(19) United States
(12) Patent Application Publication
(10) Pub. No.: US 2008/0255706 A1
(43) Pub. Date: Oct. 16, 2008

(54) Smartrepair

(76) Inventors: Jostein Aleksandersen, Randaberg (NO); Harald Syse, Royneberg (NO)

Correspondence Address: GABLE & GOTWALS, 100 WEST FIFTH STREET, 10TH FLOOR, TULSA, OK, 74103, US

(21) Appl. No.: 12/088,991

(22) PCT Filed: Sep. 14, 2006
(86) PCT No.: PCT/NO06/00316

§ 371 Date: May 1, 2008

(30) Foreign Application Priority Data
Oct. 4, 2005 (NO) 2005-4551

(51) Int. Cl. G05B 15/00; F16K 11/085

(52) U.S. Cl. 700/275; 137/625.19

(57) ABSTRACT

The present invention relates to methods and devices for positioning a plug train at a desired position within a pipeline with at least some gas in the fluid in the pipeline.

The present invention relates to methods and devices for positioning a plug train at a desired position within a pipeline to perform an activity.

There is a general need to perform maintenance and repair of existing pipeline, both onshore and offshore, possibly also underground. There may also be a need to extend the pipeline by for instance adding a branch pipe to an existing pipeline. Usually there are no existing valves to close off the pipeline, installed in the pipeline when it is laid, at the positions where one want to perform the necessary activity with or on the pipeline. One possibility is to instead use internal remotely controlled pipeline plugs which may seal off a pipeline at a desired location or perform other needed activity within the pipeline.

A plug is launched into the pipeline at a suitable place for instance a platform, pumping station or similar and then pigged by the pressure of the pipeline fluid within the pipeline to the desired location where it should be used to seal off the pipeline. Another possibility is to use a pipeline tractor to move the plug within the pipeline. To precisely position the plug at the desired location, may in most situations be difficult and involve so many uncertainties that is it not acceptable. This is particularly the case when the plug is moved a long distance through a pipeline or there are gases in the fluid in the pipeline.

A gas is compressible so measuring the added quantity and pressure of the gas behind the plug when pigging it does not give a good indication on where the plug is within the pipeline. With a liquid fluid pigging the plug one may with a descent degree of certainty say where the plug is within the pipeline by measuring the added liquid behind the plug. Gas is as said compressible and when one stops adding gas behind the plug, the plug will continue forward within the pipeline until one reaches equilibrium between the external pressures and friction between the plug and the pipeline, it is almost impossible to measure or calculate where the plug will stop in such an incident. There is also the issue that during pigging the plug is only occupying a part of the pipeline so there will necessary be some leakage and there is also normally allowed some leakage across the plug train which gives another uncertainty. Another possibility is to use pipeline tractors to move the plug through the pipeline, this however is not a solution when the distance becomes longer, both due to capacity of the tractors etc. and it is more favorable both with regards to ease and speed to have the units pigged for longer distances.

Another uncertainty may be because the distance from the entry point to the point of use is very long and even with a homogenous fluid as a liquid this length may create an uncertainty of the position of the plug.

Normally one will in these incidents where there are gas within the fluid or a long distance to be pigged, use an odometer wheel, however the accuracy of such an wheel are not good enough when the distance becomes longer.

In this sense there is, with longer pipelines, a need for a solution where one may set a plug at a desired location and know with a known degree of certainty that the plug is set at that position. These pipelines may extend from one facility to another facility, for instance a well location and a processing facility onshore or offshore or a combination of these, or a pipeline across a country or from one country to another country. There is also a need to provide a solution to precisely position a plug within the pipeline, when the pipeline fluid contains at least some gas.

There may quite often be a need to pig two plugs after each other to seal off a section of a pipeline, so that a repair, maintenance or other work may be done to the pipeline between the two set plugs. In this there is an additional difficulty of keeping these two plugs at a given distance from each other when pigging them in the pipeline and setting them both at the desired locations. With regards to this there are both the difficulties of stopping a plug at a desired position within a pipeline and also the issue of not knowing exact how much fluid i.e. distance there is between the plug as they are pigged. It is important that they keep the distance between them and don't collide within the pipeline.

An aim with the present invention is to provide a solution which allows a plug to be set at a specific position within a pipeline, even if the pipeline is a gas leading pipeline. There is also an aim to provide a method which might be used with long distance an entry point for the plug and the usage point within the pipeline. Another issue is to provide a method wherein one with certainty can pig several plug trains within a pipeline.

These aims are achieved with the methods and devices as described in the attached claims.

The present invention regards in a first aspect, a method for stopping at least one plug train, within a pipeline with at least some gas in the fluid in the pipeline at a desired location. The at least one plug train is inserting into the pipeline, preferably at a launching site for inserting plugs and pigs into the pipeline. This launching site may be a long distance from where the plug train is going to perform its activity. The plug train is when it is within the pipeline pigged through the pipeline by pressurizing the fluid added to the pipeline behind the plug train, i.e. at the rear of the plug train.

Means for deciding the position of the plug train will after a while indicate that the plug train is at a given location. These means for deciding the position may have several configurations or be a combination of several configurations. One possibility is that the plug train passes a sender positioned outside the pipeline and sends a signal to elements within the plug and thereby determines the position of the plug train. By a sender positioned outside, one should in this application understand both just a sender unit positioned on the outside wall of the pipeline, senders positioned on know places sending signals to the unit within the pug train or it may also be satellites generating for instance GPS-signals received by the unit within the plug train for thereby deciding the position of the plug train. This may for instance be done if the pipeline is a plastic or composite pipeline. The position decided may either be a position of geometrical coordinates and or the distance to a position where the plug train should be stopped. This may also be a two ways communication to give indications to the operator that the plug train has passed the sender. For onshore pipelines and if the pipeline is to be repaired there will be personnel and equipment ready at the outside of the pipeline, which personnel easily may position a sender outside the pipeline a distance in advance of and or after the part of the pipeline to be repaired, mended, branched etc. The senders may even be handheld at each side of the repair site. One other possibility is to have an inertial navigational system within the plug train which determines when the plug train is at a given position. This system may also be communicating with remote units giving data to the operator of the system. The plug may also be equipped with a combination of these systems.

When the plug train is at this position a braking device is activated breaking the speed of the plug train to a stop at or close to the desired location where after a gripping device of the plug train may be activated to grip against the inner wall of the pipeline. In addition there may also be activated sealing means for seal against the inner wall of the pipeline and forming a sealing barrier between two parts of the pipeline. The gripping means may be activated with the same function as the sealing means. Another possibility is that the griping means are the braking means, where the friction force between the means and the wall is increased to grip the wall. The braking means of the plug train may also be elements regulating the flow of pipeline fluid passing the plug train.

By the phrasing “stop/stopping the plug train” or “brake to a stop” it should in this application be understood reducing the speed of the plug train sufficiently so that one are able to set for instance a plug module of the plug train at the desired location, so that one may seal off the pipeline.

In one embodiment there are steps within the method to get a fine positioning of the plug train either further down or a bit backwards in the pipeline from the point the plug train has stopped due to the braking of the plug train. After the plug train has stopped or reduced its speed necessarily due to braking of the plug train a tractor device within the plug train may be activated and the tractor device will then move the plug train to the desired location with a forward or backwards movement within the pipe.

In a second embodiment of the invention the plug train may be pigged through the pipeline, then the pigging activity is stopped due to elements as described in the previous embodiment. The plug train will thereafter continue a distance further down the pipeline until it stops, due to equilibrium of the pressure around the plug and the friction forces between the plug train and the pipeline wall. When the plug train has stopped or the speed of the plug train is sufficiently low, a tractor device will be activated and then the plug train will be moved to the desired position and gripping means of the plug train will be activated and grip the internal wall of the pipeline.

According to an aspect of the invention the methods may comprise the steps of letting the plug train pass a first position indicator and a second position indicator arranged outside the pipeline with a given intermediate distance, and a module within the plug train will receive the signals from the indicators and thereby calculate the traveling speed of the plug train within the pipeline and thereby establish either the force needed to brake the plug train to a stop or the distance the plug train will travel after the pigging action is stopped. In one embodiment, one of the indicators may be included in or be the first sender to activate the braking device of the plug train.

In another embodiment of the method there are at least two plug trains pigged after each other within the pipeline. Means at one of the plug trains determines the one plug train to be at a specific location within the pipeline and braking devices of the one plug trains are activated, braking the speed of the one plug train to a stop at the desired location and signals are transmitted between the plug trains in the pipeline whereby one may adjust the speed of the other plug trains to the one plug train. The one plug which first brakes and stops may be the first plug train pigged down the pipeline or the second or the last plug train pigged down the pipeline. The other plug trains may be continued to be pigged until they reach their desired position, by either allowing fluid to pass through the first stopped plug train, possibly further plug train, by for instance only using the braking devices to hold the plug trains at their positions until the last plug train is stopped at its position. Another possibility is to use eventual branch pipes to add fluid behind the plug trains to be further plugged or take out pigging fluid behind an already stopped plug train. Another possibility is to set a plug module of the plug train so that it seals against the inner wall of the pipeline, but allowing fluid to pass through a lockable opening through the plug module.

In another embodiment of the method there are at least two plug trains and one plug train is pigged until it has passed two senders and then stopped. The two senders are arranged outside the pipeline and are sending signals into the plug trains within the pipeline. This may for instance be done by personnel at the site where one wants to perform reparation of the pipeline. The other plug train is pigged until it reaches the first sender and then stopped. This may be done by either stopping the first plug train in the chain of plug trains where there is a branch of the pipeline between the two positions of stopping two after each other arranged plug trains or setting the last of the second plug trains before the first plug train and pigging the first of the plug trains with the help of the branched pipeline, or allowing fluid through the stopped plug train before the plug module is activated.

In yet another embodiment of the method there are at least two plug trains and the plug trains transmit and receive signals to and from each other. By this one may control that the plug trains keep a set distance between them when they are pigged a longer distance within a pipeline. This communication is important since there is a non measurable leakage across the plug trains especially when they are pigged in a pipeline with at least some gas and one there can't have full control on where the plug trains are relative to each other just by regulating the pigging. According to the method the first stopped plug train is allowing fluid to pass the stopped plug train until the other plug train is stopped at its desired location. This may be done by not setting plugging devices of the plug train and thereby allowing fluid to pass, or setting a plugging unit of the plug train to seal against the inner wall of the pipeline and open a lockable passage opening in the set plug allowing fluid to pass the plug.

Another element of the invention which may be incorporated within the previous mentioned methods are that the braking device may be activated during the pigging of the plug train and the retardation of the plug train measured, the braking device is there after released and the procedure repeated to calibrate the braking effect of the braking device of the plug train before the plug train is braked to a stop at the desired location.

According to another aspect of the invention there is also provided a method to determine the position of a plug train moved within a pipeline by pigging and or by a pipeline tractor or other means, wherein an inertial navigational system for at least one axis, determines the position of the plug train and uses the information for the activating functions to stop the plug train at the desired position.

According to the invention there is also provided a plug train which may be stopped at a desired location for performing an activity within a pipeline. The activity might be to set a plug within the pipeline to seal off between two sections of the pipeline and there after removed again. With this one may, after the plug is set reduce the pressure on one side of the plug for instance by letting the fluid at that side of the plug out of the pipeline. One may also bleed of the pressure between two plug trains when two plugs are set with a distance. By setting two such plug trains with plugs at different locations one can let out the fluid between the plugs and either perform reparation, replace a pipe section with another or similar activity.

The plug train according to the invention comprises at least one element. There may in different embodiments be several elements liked to each other by connections to for instance provide a better possibility of running the plug train through a pipe bend or have the flexibility to assemble the necessary units in the plug train for the next job to be performed. There may for instance be a braking unit, a plugging unit, a pigging unit, a measuring unit, a control unit etc., or any combinations of these. The plug trains comprise means making it possible to pig the plug train within the pipeline with at least a portion of gas in the pipeline fluid.

The plug train comprises in an embodiment also braking means for breaking the speed of the plug train when it comes closer to the desired location. These braking means may preferably be a separate device of the plug train but it is possible that the braking and gripping means are the same element. The braking means has preferably systems making it possible to adjust the friction between the plug train and the pipeline and thereby adjusting the braking effect making the plug train stop at a desired location. There are also means for measuring speed and or position of the plug train within the pipeline. The activity to be performed is most likely to seal off between two sections of the pipeline, and the plug train therefore comprises a plug module, with gripping and sealing means. These may be slips and gripping means and a circumferential packer as the sealing means moved from an unset position to a set position in abutment against the inner wall of the pipeline by a fluid cylinder with a piston, i.e. a hydraulic cylinder operating both the sealing and gripping means, and positioned centrally within the body of the plugging module. There will in the plug train be a control module for operating the elements and means within the plug train.

In an embodiment of the invention the plug train comprises means for receiving signals from at least one sender positioned outside the pipeline when the plug train passes the sender. The plug train may also comprise means for transmitting and receiving signals from another plug train within the pipeline.

In an embodiment the plug train also comprises a pipeline tractor device for moving the plug train within the pipeline. This may be done either after the plug train has stopped due to the activation of the braking means of the pug train or after it has stopped as a consequence of stopping of the pigging actions. The tractor device is in one embodiment formed so that it may pull/push the plug train in either direction within the pipeline. There may in an embodiment also be a solution with only one way drive of the tractor device. The tractor device may have several sets of wheel arranged around the circumference of the plug train, where one, or more of the wheels are driven by a drive unit. There may be a belt arrangement around sets of turning points or running wheels for the belt, where at least one of the tuning points has a driving function. These wheels and or belt function may be retractable and extendable for being retracted when it is pigged through the pipeline and then extended into contact with the pipeline wall when it is activated. The wheels and or belt function may also comprise a spring device keeping at firm contact between pipe wall and wheel or belt function in an activated state. The tractor device may also be a separate unit or it may be formed by wheels attached to the plugging unit, which when the tractor device is activated at least one of the wheels change from a free running mode to an actively driven mode.

The plug train may also comprise means to calibrate the effect of the braking device during pigging of the plug train, before the plug train is braked to a stop at the desired location.

In an embodiment of the invention the plug module may comprise means which may allow fluid within the pipeline to pass the plug module when the plug module is set within the pipeline to grip and seal against the internal wall of the pipeline. This is favorable to have when there are set two or more plug modules within the pipeline. In this instance one need to have the possibility to fill the void between the plugs, which is tapped for fluid to perform the work on the pipeline onshore but in offshore situations the void will be filled with seawater or freshwater from a lake if the pipeline goes through a lake onshore, and there will be a need to balance the pressure in the fluid between the plug trains, to be able to use pigging to get the plug trains out of the pipeline after the job is done.

In one embodiment of the invention the first plug train may be inserted within the pipeline, and a liquid added behind the first plug train until a second or last plug train is inserted into the pipeline where after original pipeline fluid comprising at least some gas, is added behind the last plug train to pig the plug trains within the pipeline. This gives to possibility of for instance having an environmentally friendly fluid between the plug trains which may easily be just lest out at the site for repairing of the pipeline.

The invention will now be explained in some more detail with some embodiments of the invention, shown in the accompanying drawing, where:

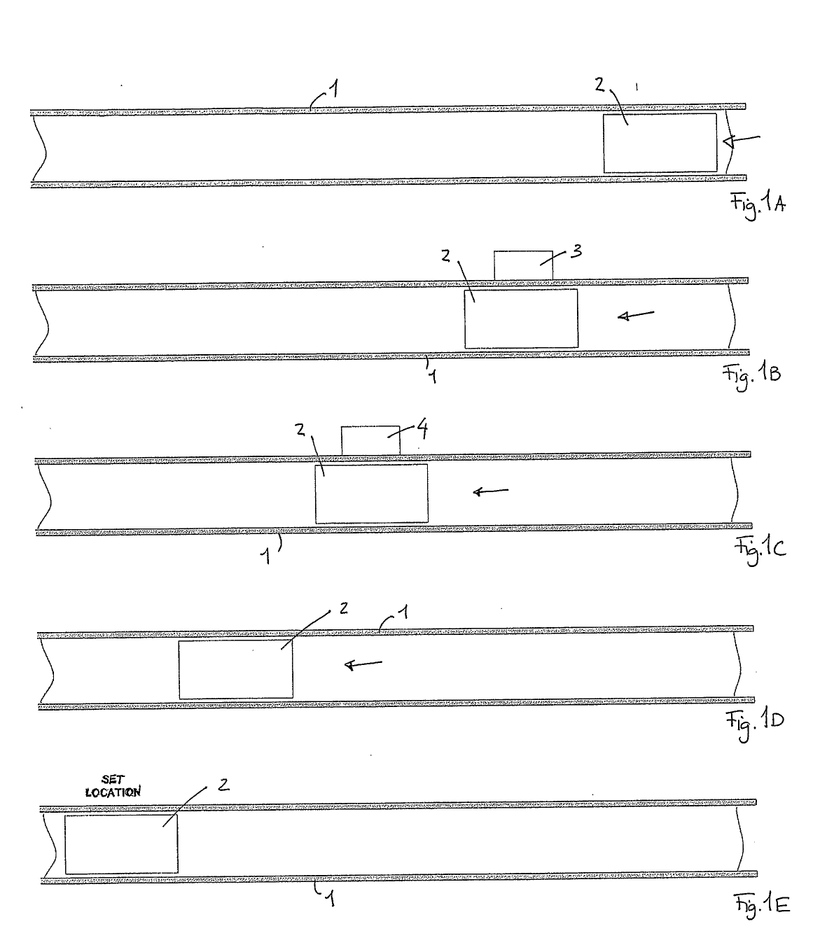

FIG. 1A-E schematically show a plug train at specific positions within a pipeline,

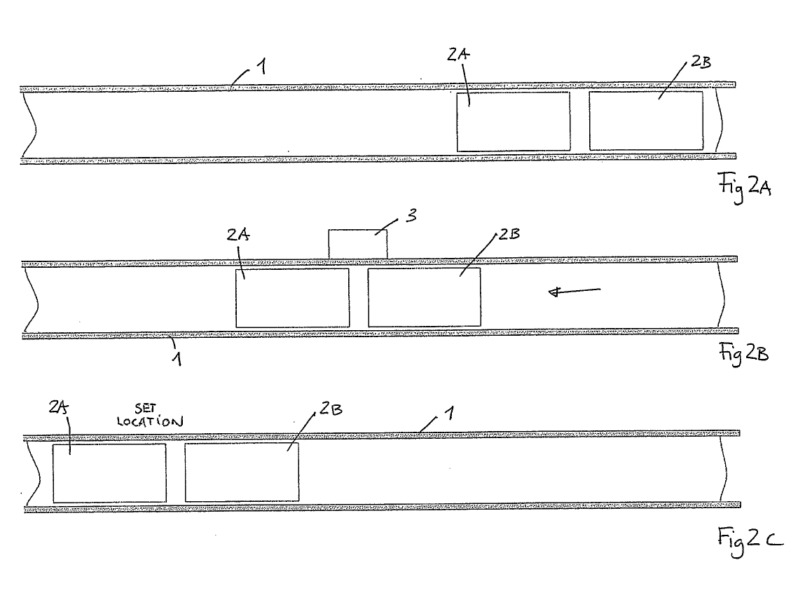

FIG. 2A-C schematically show two plug trains within a pipeline,

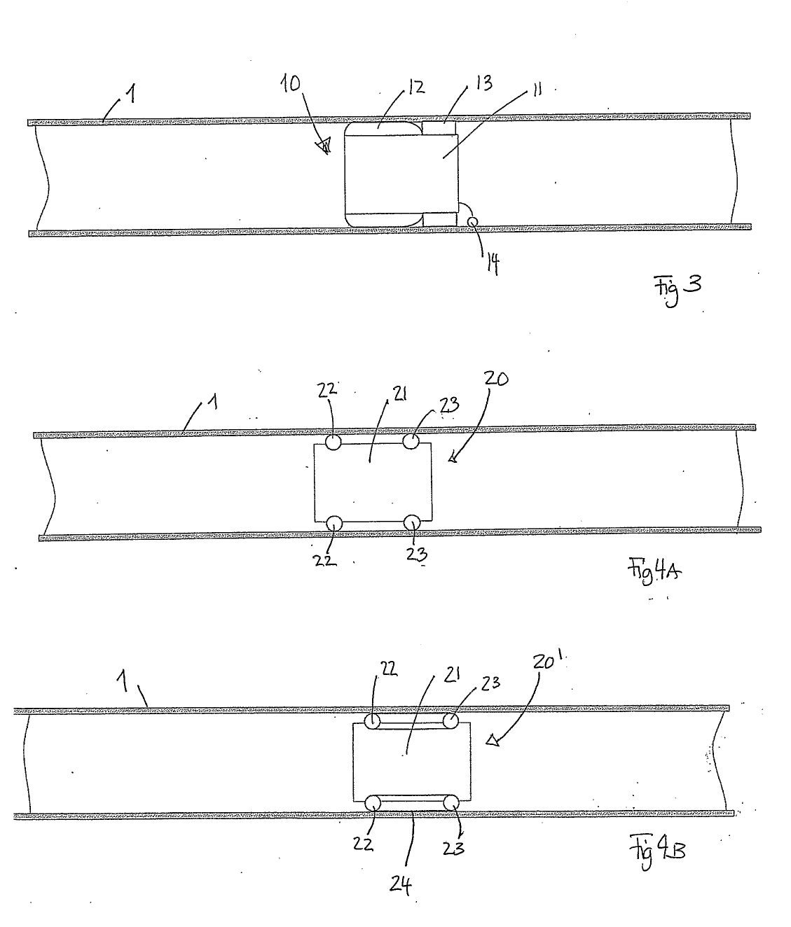

FIG. 3 shows a possible braking module of a plug train,

FIG. 4A-B shows two possible configurations for a pipeline tractor solution.

In FIG. 1A-C there are schematically shown a plug train 2 within a pipeline 1—the plug train 2 is through pigging, adding fluid at the back of the plug train 2 moved through the pipeline 1 in the direction of arrow A in FIG. 1A-D. In FIG. 1A the plug train 2 is just launched into the pipeline 1 at a suitable location for this procedure. This is a well know procedure for a skilled person and will therefore not be explained any further. When the plug train 2 is moved further down the pipeline 1 it passes a first sender 3, positioned outside the pipeline 1, FIG. 1B, and further down the plug train 2 passes a second sender 4, FIG. 1C. By receiving signals from these two senders a unit (not shown) within the plug train 2 may calculate the speed of the plug train 2 and the needed braking action of the braking devices within the plug train 2, which will be formed in a situation as in FIG. 1D, where the plug train still might be pigged within the pipeline but at the same time using its braking device. In another method the pigging action will be stopped and the plug will continue to move through the pipeline either with or without the use of braking the plug until it has reached the set location, shown in FIG. 1E, where the plug train is stopped within the pipeline and a plugging module (not shown) may be activated to seal off the two sides of the pipeline divided by the plug train 2.

In FIG. 2A-C there is shown a similar situation, but with two plug trains 2A and 2B pigged after each other within the pipeline, FIG. 2A. These plug trains are preferably in contact with each other, with sending signals to each other through the fluid within the pipeline or the pipeline it self, keeping the distance between them within a allowable range. The two plug trains 2A, 2B will pass a first sender 3, FIG. 2B and thereby activate the stopping procedure, either by continue pigging and braking or stopping pigging and breaking the plug train 2A, 2B. When they are stopped they are either at set location as shown in FIG. 2C or they are move by tractor devices within the plug trains 2A, 2B to the set location and then plugging modules within the plug trains 2A and 2B can be activated sealing off the part of the pipeline 1 between the two plug trains.

In FIG. 3 there is shown a possible schematic braking module 10 within a pipeline 1, which may form part of a plug train. The braking module 10 comprises in this non-limiting embodiment a body 11, centralizing means for keeping the module with its centre axis aligned with the centre axis of the pipeline, and braking shoes 13, which interact with the internal wall of the pipeline to brake the speed of the plug trains.

In FIG. 4A and FIG. 4B there are shown two different schematic embodiments of a pipeline tractor device 20. This tractor device 20 comprises a body 21, and a first set of wheels 22 and a second set of wheels 23. In the embodiment in FIG. 4A the first set of running wheels 22 or the second set of running wheels 23 or both may in an activated state of the tractor device 20 be driven wheels, which may driven in either direction. In FIG. 4B there is a belt device 24 attached around units of the first wheel set 22 and the second wheel set 23, which belt device 24 is interacting with the pipeline wall to move the plug train in any direction within the pipeline 1. The wheel sets in these embodiments may be rollers, tuning axes or other means to make the belt perform the necessary action on the pipeline wall. These first and second set of wheels may be retractable in an inactive state or run free until they are activated.

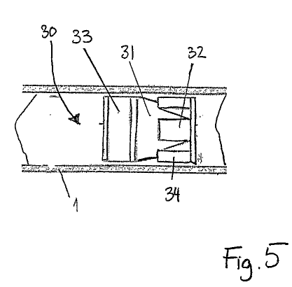

In FIG. 5 there is shown a possible plugging module 30 within a pipeline 1 in an unset configuration, for a plug train according to the invention. A plug module 30 may comprise a body 31, and gripping means 32 in the form of wedge formed slip segments 34 arranged spaced around the circumference of the body. These slip segments 34 will be moved outwards to contact with the pipeline wall by moving them on a conical or oblique shaped part of the plug module. The sealing means 33 may be in the form of a packer arranged around the circumference of the body 32. This plug module has a configuration making it self locking with a given differential pressure across the plug module. The gripping and sealing means are favorably activated by a centrally located fluid cylinder with a piston in the centre of the body.

There has now been explained some devices which may be used with the invention as it is stated in the attached claims. A skilled person will understand that there are several alterations and modifications to the devices which are well within the scope of the invention as stated in the claims. There may be a plug train with any configurations of combinations the devices explained above and the different devices may have other configurations. There may be a separate control module in the plug train or the control module may be incorporated within one of the other modules in the plug train, and so further. The pipelines may be a metal pipeline but the system according to the invention may well be performed on pipelines made of a different material, as for instance composite, plastic etc. One may use GPS or other similar systems to decide the position of the plug train. The plug train may be equipped with means to send out signals to the outside of the pipeline, which signals may be transmitted to for instance an operator. The plug train may be equipped with other tool for performing different operations during pigging and or stopping of the plug train. A plug module of the plug train may in some cases be activated before the plug train has stopped fully within the pipeline.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. Method for stopping at least one plug train, within a pipeline with at least some gas in the fluid in the pipeline at a desired location, said method comprising:
inserting the at least one plug train within the pipeline;
pigging the plug train in the pipeline by pressurizing the fluid at the back of the plug train;
locating the position of the plug train;
braking the speed of the plug train near the desired location; and
activating a gripping means to position the plug train by gripping the inner wall of the pipeline.

19. The method of claim 18 said locating of the plug train further comprising the plug train receiving a signal from a sender located outside the pipeline.

20. The method of claim 18 said locating of the plug train further comprising using an inertial navigational system located within the plug train.

21. Method according to claim 18, further comprising:
activating a tractor device within the plug train to move the plug train to the desired location.

22. Method according to claim 18, said locating the plug train further comprising:
the plug train passing a first position indicator and a second position indicator arranged outside the pipeline with a given intermediate distance;
a module within the plug train receiving a signal from the first and second indicators; and
the module calculating the traveling speed of the plug train within the pipeline.

23. Method according to claim 18, said locating the plug train further comprising:
the plug train is passing a first position indicator and a second position indicator arranged outside the pipeline with a given intermediate distance;
a module within the plug train receiving a signal from the first and second indicators; and
the module calculating the force needed to brake the plug train.

24. The method according to claim 18, said locating the plug train further comprising:
the plug train passing a first position indicator and a second position indicator arranged outside the pipeline with a given intermediate distance;
a module within the plug train receiving a signal from the first and second indicators; and the module calculating the distance the plug train will continue to move within the pipeline after the pigging action is stopped.

25. The method according to claim 18, further comprising:
pigging a second plug train after a first plug train within the pipeline;
determining the specific location within the pipeline for the first plug train;
stopping the first plug train at the desired location;
transmitting a signal between the first and second plug trains in the pipeline;
adjusting the speed of the second plug train in response to the signal; and
stopping the second plug train at a second desired location.

26. The method according to claim 18, further comprising:
pigging a first plug train past a first sender and a second sender both arranged outside the pipeline;
the second sender sending a signal to the first plug train;
stopping the first plug train at the second sender;
pigging a second plug train past the first sender;
the first sender sending a signal to the second plug train; and
stopping the second plug train at the first sender.

27. The method according to claim 18, further comprising:
a first and a second plug train each transmitting a signal and receiving a signal between each other;
stopping a first plug train;
the first plug train allowing fluid to pass the plug train until the second plug train is at a desired location;
the first plug train stopping the second plug train by sealing off the pipeline; and
creating a sealed area between the first and second plug trains by the second plug train sealing off the pipeline.

28. The method according to claim 18, further comprising:
measuring the retardation of the braking at least twice;
calibrating the braking based on the measuring.

29. Method for determine the position of a plug train within a pipeline comprising:
providing an inertial navigational system for at least one axis; and
determining the position of the plug train using the inertial navigational system.

30. Method for stopping at least one plug train, within a pipeline at a desired location, said method comprising:
inserting the at least one plug train within the pipeline, pigging the plug train in the pipeline by pressurizing the fluid at the back of the plug train, when means for deciding the position of the plug train indicates the plug train to be at a given location; stopping the pigging of the plug train;
activating a tractor device within the plug train;
moving the plug train to the desired position within the pipeline through use of the tractor device; and
gripping the inner wall of the pipeline.

31. A plug train for performing an activity within a pipeline at a desired location, said plug train comprising:
a means for pigging the plug train within the pipeline with at least a portion of gas in the pipeline fluid;
a means for braking the speed of the plug train when is comes a desired location; a means for measuring speed of the plug train within the pipeline;
a means for measuring the location of the plug train within the pipeline;
a means for performing the activity within the pipeline;
a control module for operating the means within the plug train; and
a means for sealing said plug train against an inner wall of the pipeline.

32. A plug train according to claim 31, said control module comprising a means for receiving a signal.

33. A plug train according to claim 31, said control module further comprising a means for transmitting a signal.

34. A plug train according to claim 31, further comprising a pipeline tractor device for moving the plug train within the pipeline.

35. A plug train according to claim 31, further comprising a means to calibrate the effect of a means for braking during pigging.

36. A plug train according to claim 31, further comprising a plug module, a control module, a braking module, and a tractor device.

37. A plug train according to claim 36, said plug module comprising a means to allow fluid within the pipeline to pass the plug module when the plug module is set within the pipeline.

38. A plug train according to claim 36, said control module comprising an inertial navigational system for at least one axis which determines the position of the unit.
